(19) United States
(12) Patent Application Publication
(10) Pub. No.: US 2026/0329560 A1
(43) Pub. Date: Oct. 22, 2026

(54) METHOD FOR PERFORMING PATCH PORTING CONTROL TO ENHANCE PATCH PORTING EFFICIENCY WITH AID OF ARTIFICIAL INTELLIGENCE-POWERED PATCH PORTING ARCHITECTURE, ASSOCIATED APPARATUS AND ASSOCIATED COMPUTER-READABLE MEDIUM

(71) Applicant: MEDIATEK INC., Hsinchu City (TW)

(72) Inventors: Ting-Hao Yeh, Hsinchu City (TW); Yao-Chung Wang, Hsinchu City (TW); Min-Shan Huang, Hsinchu City (TW); Yu-Sheng Tseng, Hsinchu City (TW); Pin-Jie Liao, Hsinchu City (TW); Jhen-Yao Hong, Hsinchu City (TW); Yen-Jen Tai, Hsinchu City (TW); Ping-Yang Liang, Hsinchu City (TW); Tai-Jung Chang, Hsinchu City (TW)

(73) Assignee: MEDIATEK INC., Hsinchu City (TW)

(21) Appl. No.: 19/181,320

(22) Filed: Apr. 16, 2025

(51) Int. Cl. G06F 8/51; G06N 5/04

(52) U.S. Cl. CPC G06F 8/51; G06N 5/04

(57) ABSTRACT

A method for performing patch porting control to enhance patch porting efficiency and an associated apparatus are provided. The method applicable to a processing circuit within an electronic device may include: utilizing the processing circuit to run a hybrid artificial intelligence (AI) framework, the hybrid AI framework comprising AI-powered patch porting architecture, for generating at least one AI judgment according to at least one source code change of a source code; and selectively performing inference according to the aforementioned at least one AI judgment, for selectively generating at least one new code change as at least one patch for patch porting from the source code to a destination code.

### BACKGROUND

The present invention is related to program debugging, and more particularly, to a method for performing patch porting control to enhance patch porting efficiency, an associated apparatus and an associated computer-readable medium.

According to the related art, in any two code lines that frequently have inter-referential behavior, porting patches consumes a significant amount of development time. For example, there may be a huge number of patch lists that need to be reviewed one by one for determining whether it is necessary to port one or more patches from the source branch to the destination branch. In addition, the owner may then have to try to cherry-pick them and handle conflicts manually to complete the task. Thus, a novel method and associated architecture are needed for solving the problems without introducing any side effect or in a way that is less likely to introduce a side effect.

### SUMMARY

It is an objective of the present invention to provide a method for performing patch porting control to enhance patch porting efficiency, an associated apparatus and an associated computer-readable medium, in order to solve the above-mentioned problems.

At least one embodiment of the present invention provides a method for performing patch porting control to enhance patch porting efficiency, where the method can be applied to a processing circuit within an electronic device. For example, the method may comprise: utilizing the processing circuit to run a hybrid artificial intelligence (AI) framework, the hybrid AI framework comprising AI-powered patch porting architecture, for generating at least one AI judgment according to at least one source code change of a source code; and selectively performing inference according to the aforementioned at least one AI judgment within the AI-powered patch porting architecture, for selectively generating at least one new code change as at least one patch for patch porting from the source code to a destination code. For example, generating the aforementioned at least one AI judgment according to the aforementioned at least one source code change of the source code may further comprise generating at least one prompt according to the aforementioned at least one source code change of the source code, and selectively performing the inference according to the aforementioned at least one AI judgment within the AI-powered patch porting architecture for selectively generating the aforementioned at least one new code change as the aforementioned at least one patch for the patch porting from the source code to the destination code may further comprise performing the inference according to the aforementioned at least one prompt within the AI-powered patch porting architecture, for selectively generating the aforementioned at least one new code change as the aforementioned at least one patch for the patch porting from the source code to the destination code. According to some embodiments, the AI-powered patch porting architecture may comprise a natural language processing (NLP) module, and generating the aforementioned at least one prompt according to the aforementioned at least one source code change of the source code may further comprise: using the NLP module during preprocessing according to the aforementioned at least one source code change of the source code. More particularly, the AI-powered patch porting architecture may further comprise a trained generative artificial intelligence (GAI) module, and performing the inference according to the aforementioned at least one prompt within the AI-powered patch porting architecture for selectively generating the aforementioned at least one new code change as the aforementioned at least one patch for the patch porting from the source code to the destination code may further comprise: performing the inference according to the aforementioned at least one prompt with the trained GAI module within the AI-powered patch porting architecture, for selectively generating the aforementioned at least one new code change as the aforementioned at least one patch for the patch porting from the source code to the destination code.

At least one embodiment of the present invention provides an apparatus that operates according to the above method, where the apparatus may comprise at least the processing circuit within the electronic device. According to some embodiments, the apparatus may comprise the whole of the electronic device.

At least one embodiment of the present invention provides a computer-readable medium related to the above method, where the computer-readable medium may store a program code which causes the processing circuit to operate according to the method when executed by the processing circuit.

It is an advantage of the present invention that, the method of the present invention, as well as the associated apparatus such as the processing circuit and the electronic device, can provide an AI-powered solution to conveniently complete any patch porting task, especially if the patch is going to be applied to a heterogeneous system. The method of the present invention can combine NLP for locating similar code chunks in branches and GAI for providing the associated inference results, including but not limited to: necessary reasons and available code modifications. This allows the owner to complete these tasks quickly with ease instead of manual reviewing and modification. In addition, the method of the present invention, as well as the associated apparatus such as the processing circuit and the electronic device, can solve the problems in the related art without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates, in the lower half part thereof, an AI-powered patch porting control scheme of a method for performing patch porting control to enhance patch porting efficiency according to an embodiment of the present invention, where a non-AI-powered patch porting control scheme is illustrated in the upper half part of FIG. 1 for better comprehension.

FIG. 2 is a diagram illustrating a first hybrid AI control scheme of the method according to an embodiment of the present invention.

FIG. 3 is a diagram illustrating a second hybrid AI control scheme of the method according to an embodiment of the present invention.

FIG. 4 is a diagram illustrating an example of comparison between the AI-powered patch porting control scheme and the non-AI-powered patch porting control scheme shown in FIG. 1 according to an embodiment of the present invention.

FIG. 5 is a diagram illustrating an electronic device involved with the method according to an embodiment of the present invention.

FIG. 6 is a flowchart of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

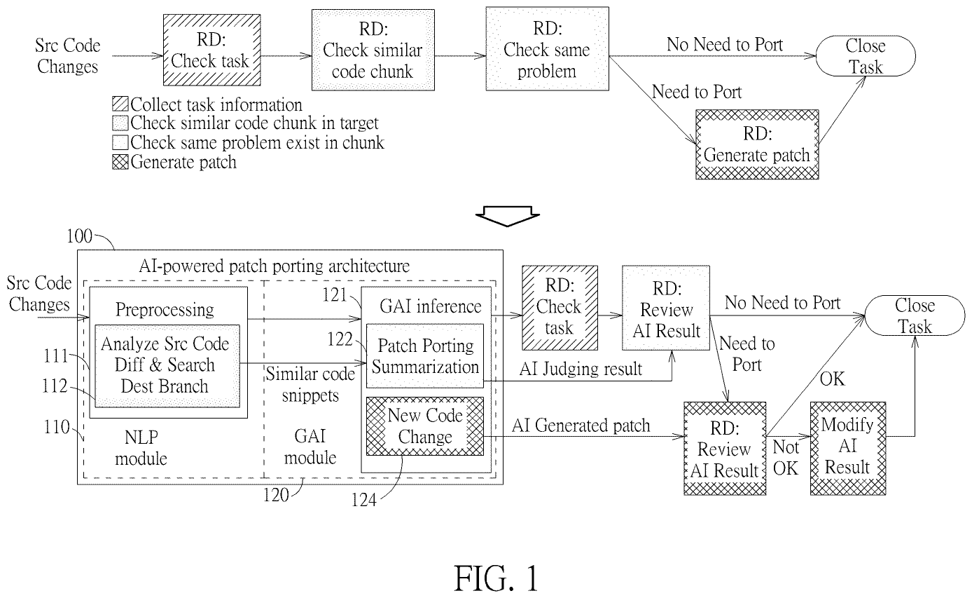

FIG. 1 illustrates, in the lower half part thereof, an AI-powered patch porting control scheme of a method for performing patch porting control to enhance patch porting efficiency according to an embodiment of the present invention, where a non-AI-powered patch porting control scheme is illustrated in the upper half part of FIG. 1 for better comprehension. Based on the non-AI-powered patch porting control scheme, a patch porting standard (or standing) operating procedure (SOP) may comprise: (1) Collect the task information; (2) Check similar code chunk(s) in the target; (3) Check if the same problem(s) exist in the chunk(s); and (4) Generate patch(es). For example, a group of research and development (R&D) engineers (labeled “RD” for brevity) may be arranged to carry out a series of operations according to the patch porting SOP, and spend a lot of time on the series of operations until closing the whole task. Typically, in any two code lines that frequently have inter-referential behavior, porting patches consumes a significant amount of development time. There may be a huge number of patch lists that need to be reviewed one by one for determining whether it is necessary to port one or more patches from the source branch to the destination branch. In addition, the owner may then have to try to cherry-pick them and handle conflicts manually to complete the task.

Based on the non-AI-powered patch porting control scheme, the associated apparatus operating according to the method, such as a processing circuit, an electronic device comprising the processing circuit, etc., can be equipped with an AI-powered patch porting architecture 100 to conveniently complete any patch porting task in an efficient manner, no matter whether the patch is going to be applied to any heterogeneous system or not, and can extremely save software manpower, in particular, if the patch is going to be applied to the heterogeneous system. For example, the AI-powered patch porting architecture 100 comprises an NLP module 110 for locating similar code chunks in branches, and further comprises a trained GAI module such as a GAI module 120 which has been trained for providing the associated inference results such as necessary reasons, available code modifications, etc., allowing the owner to complete these tasks quickly with ease instead of manual reviewing and modification. The NLP module 110 can use preprocessing 111 to generate at least one prompt according to at least one source code change (e.g., one or more source code changes, or “Src Code Changes” for brevity) of a source code, and the trained GAI module such as the GAI module 120 can perform inference such as GAI inference 121 according to the aforementioned at least one prompt, for selectively generating at least one new code change (e.g., one or more new code changes) as at least one patch (e.g., one or more patches) for patch porting from the source code to a destination code. The NLP module 110 can be arranged to analyze the aforementioned at least one source code change to determine whether there is any similar part. If it is determined that there is any similar part, the NLP module 110 can determine that using the preprocessing 111 to generate prompt(s) is required, and therefore the preprocessing 111 generates the aforementioned at least one prompt. If it is determined that there is no similar part, the NLP module 110 can determine that there is no need to generate any prompt by using the preprocessing 111, and therefore the preprocessing 111 does not generate the aforementioned at least one prompt. For better comprehension, the aforementioned at least one source code change may comprises at least one source code difference (e.g., one or more source code differences) between a previous version and a current version of the source code.

Within the AI-powered patch porting architecture 100, the NLP module 110 can use the preprocessing 111 to generate the aforementioned at least one prompt according to the aforementioned at least one source code change of the source code, and more particularly, preprocess the aforementioned at least one source code change of the source code to generate the aforementioned at least one prompt, for prompting the trained GAI module such as the GAI module 120 to perform the aforementioned inference such as the GAI inference 121. For example, the aforementioned inference such as the GAI inference 121 comprises the inference of determining whether the patch porting is needed to generate a determination result, and further comprises the inference of selectively generating the aforementioned at least one new code change according to the determination result. In addition, the determination result can indicate whether the patch porting is needed. When the determination result is equal to a first determination result (e.g., a positive determination result) indicating that the patch porting is needed, the GAI inference 121 can generate the aforementioned at least one new code change as the aforementioned at least one patch for the patch porting. When the determination result is equal to a second determination result (e.g., a negative determination result) indicating that the patch porting is not needed, the GAI inference 121 can reach or enter an early termination, rather than generating the aforementioned at least one new code change as the aforementioned at least one patch for the patch porting, to allow the owner such as the R&D engineer(s) who are using the AI-powered patch porting architecture 100 to close the whole task. This is for illustrative purposes only, and is not meant to be a limitation of the present invention. According to some embodiments, the NLP module 110 can generate another determination result by itself to indicate whether the patch porting is needed. When the other determination result is equal to the second determination result (e.g., the negative determination result) indicating that the patch porting is not needed, the NLP module 110 can reach or enter the early termination, to allow the owner such as the R&D engineer(s) who are using the AI-powered patch porting architecture 100 to close the whole task.

As shown in FIG. 1, the preprocessing 111 (or the associated operations thereof) may comprise at least one source patch analysis operation 112 such as the operations of: analyzing the aforementioned at least one source code difference (Diff) between the previous version and the current version of the source code, for determining a set of source code snippets within at least one source branch of the source code that correspond to (e.g., comprise and/or are involved with) the aforementioned at least one source code difference; and searching at least one destination (Dest) branch (e.g., one or more destination branches) of the destination code, for determining a set of similar code snippets such as a set of destination code snippets within the aforementioned at least one destination branch that are similar to the set of source code snippets (labeled “Analyze Src Code Diff & Search Dest Branch” for brevity). In addition, the inference such as the GAI inference 121 (or the associated operations thereof) may comprise at least one inference operation (e.g., one or more inference operations) such as a patch porting summarization inference operation 122 (labeled “Patch Porting Summarization” for brevity), and a new code change inference operation 124 (labeled “New Code Change” for brevity). The patch porting summarization inference operation 122 can generate a patch porting summarization for the owner such as the R&D engineer(s) who are using the AI-powered patch porting architecture 100 so that they can review at least one AI judging result (or AI judgment) such as one or more AI judging results in the patch porting summarization (labeled “Review AI Result” for brevity), and the new code change inference operation 124 can generate the aforementioned at least one new code change as the aforementioned at least one patch for the owner such as the R&D engineer(s) who are using the AI-powered patch porting architecture 100 so that they can review the AI generated patch such as the aforementioned at least one patch (labeled “Review AI Result” for brevity). If it is determined that there is no need to port the patch from the source code (or the source branch thereof) to the destination code (or the destination branch thereof), they can close the whole task; otherwise, in a situation where it is determined that there is a need to port the patch from the source code (or the source branch thereof) to the destination code (or the destination branch thereof), they can review the AI generated patch to determine whether the AI generated patch is OK. When it is determined that the AI generated patch is OK, they can execute the patch porting and close the whole task. When it is determined that the AI generated patch is not OK, they can modify the AI generated patch (labeled “Modify AI Result” for brevity), and then execute the patch porting and close the whole task.

For example, the patch porting summarization generated by the patch porting summarization inference operation 122 may at least comprise the determination result for indicating whether the patch porting is needed, such as the determination result that is generated during the aforementioned inference of determining whether the patch porting is needed. More particularly, in response to the determination result being equal to the first determination result which indicates that the patch porting is needed, the patch porting summarization generated by the patch porting summarization inference operation 122 may further comprise one or more necessary reasons regarding why the patch porting is needed, and the aforementioned at least one inference operation may comprise the new code change inference operation 124, for generating the aforementioned at least one new code change as the aforementioned at least one patch for the patch porting from the source code to the destination code. Therefore, the AI-powered patch porting architecture 100 is helpful on reducing the human resources required for software patch porting, allowing the software engineers to focus on innovative development instead of regular bug fixing or making similar changes in new programs, by providing (1) the AI judging results (or “the AI judgments”) and (2) the AI code suggestions as references in the patch porting process, where the AI-powered patch porting architecture 100 indeed provides the source patch analysis and the available new change porting information to streamline the patch porting process.

Additionally, the NLP module 110 can use the preprocessing 111 to generate the aforementioned at least one prompt, rather than any patch list, according to the aforementioned at least one source code change of the source code, for triggering the GAI module 120 with zero-shot prompting to perform the GAI inference 121, allowing the owner such as the R&D engineers who are using the AI-powered patch porting architecture 100 to obtain the aforementioned at least one patch such as all patches that are needed from the GAI inference 121, having no need to review a large amount of patch lists and further prepare the patches by themselves according to a set of selected patch lists among the large amount of patch lists.

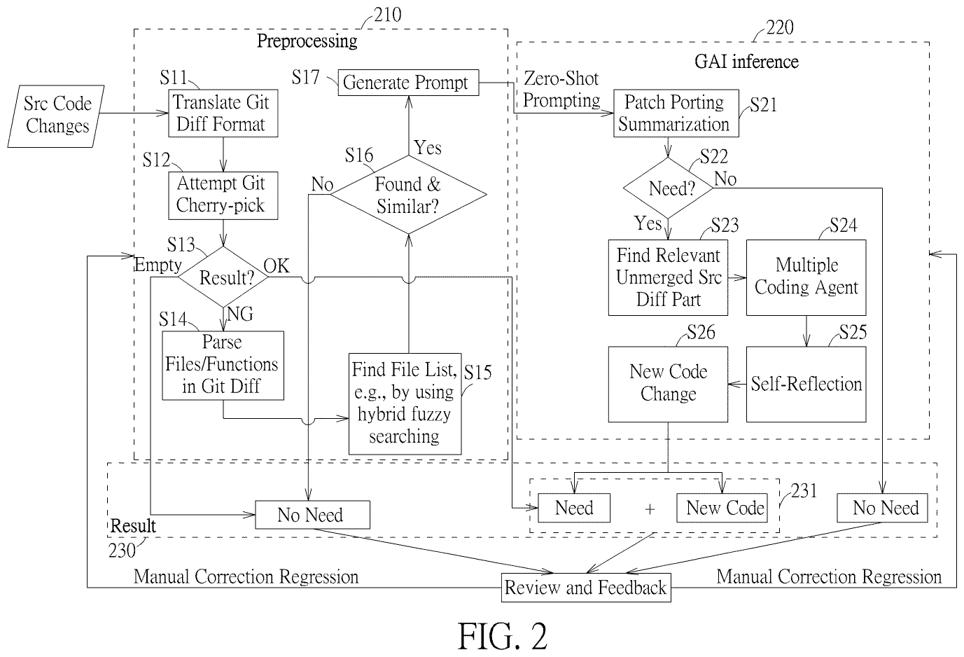

FIG. 2 is a diagram illustrating a first hybrid AI control scheme of the method according to an embodiment of the present invention, where the preprocessing 210 and the GAI inference 220 shown in FIG. 2 can be taken as examples of the preprocessing 111 and the GAI inference 121 shown in FIG. 1, respectively. Among the result 230 such as the preprocessing result of the preprocessing 210 and the inference result of the GAI inference 220, the determination results, including the positive determination result “Need” indicating that the patch porting is needed and the negative determination result “No Need” indicating that the patch porting is not needed, can be taken as examples of the AI judging result shown in FIG. 1, and the new code (e.g., the new code change obtained from the GAI inference 220) within the sub-result 231 of the result 230 can be taken as an example of the AI generated patch shown in FIG. 1.

During performing the preprocessing 210 to generate the aforementioned at least one prompt according to the aforementioned at least one source code change of the source code, the NLP module 110 is capable of using the preprocessing 210 to translate Git Diff Format in Step S11, attempt Git Cherry-pick in Step S12, determine in Step S13 the result of Git Cherry-picking, for example, by determining whether the result of Git Cherry-picking is OK or Empty or not good (NG), parse the files/functions in Git Diff in Step S14 for the case of determining that the result of Git Cherry-picking is NG, try to find at least one file list having a chunk similar to the Git Diff in Step S15, for example, by using hybrid fuzzy searching, and afterward, in Step S16, at least determine whether any file list is found, in particular, further determine whether there are some similar part(s) (labeled “Found & Similar” at Step S16 shown in FIG. 2 for brevity), and generate the aforementioned at least one prompt in Step S17 for the case that at least it is true that the aforementioned any file list is found, in particular, for the case that the aforementioned any file list is found and that the NLP module 110 confirms there are some similar part(s), in order to continue with the zero-shot prompting to trigger the GAI inference 220. In the above example, the Git can be taken as an example of the version management system involved with (e.g., invoked by) the preprocessing 210. This is for illustrative purposes only, and is not meant to be a limitation of the present invention. According to some embodiments, as long as the implementation of the present invention will not be hindered, the version management system involved with and/or invoked by the preprocessing 210 may vary.

During performing the GAI inference 220 according to the aforementioned at least one prompt, the trained GAI module such as the GAI module 120 can generate the patch porting summarization in Step S21, determine in Step S22 whether the patch porting is needed, find the relevant unmerged (or non-ported) source difference part such as the set of source code snippets (labeled “Find Relevant Unmerged Src Diff Part” for brevity) in Step S23, invoke multiple coding agents to generate at least one temporary new code change according to the set of source code snippets and the set of destination code snippets (labeled “Multiple Coding Agent” for brevity) in Step S24, perform self-reflection on the multiple coding agents for optimizing the aforementioned at least one temporary new code change (labeled “Self-Reflection” for brevity) in Step S25, and optimize the aforementioned at least one temporary new code change to generate at least one optimized result of the aforementioned at least one temporary new code change to be the aforementioned at least one new code change (labeled “New Code Change” for brevity) in Step S26.

The aforementioned owner such as the R&D engineer(s) who are using the AI-powered patch porting architecture 100 shown in FIG. 1 can review the result 230 to confirm the determination result (e.g., the positive determination result “Need” or the negative determination result “No Need”) regarding whether the patch porting is needed, and execute the patch porting according the new code within the sub-result 231 for the case of confirming that the patch porting is needed, and can send feedback to the AI-powered patch porting architecture 100 in order to perform manual correction regression on the preprocessing 210 and the GAI inference 220 (or the learning parameters thereof). For brevity, similar descriptions for this embodiment are not repeated in detail here.

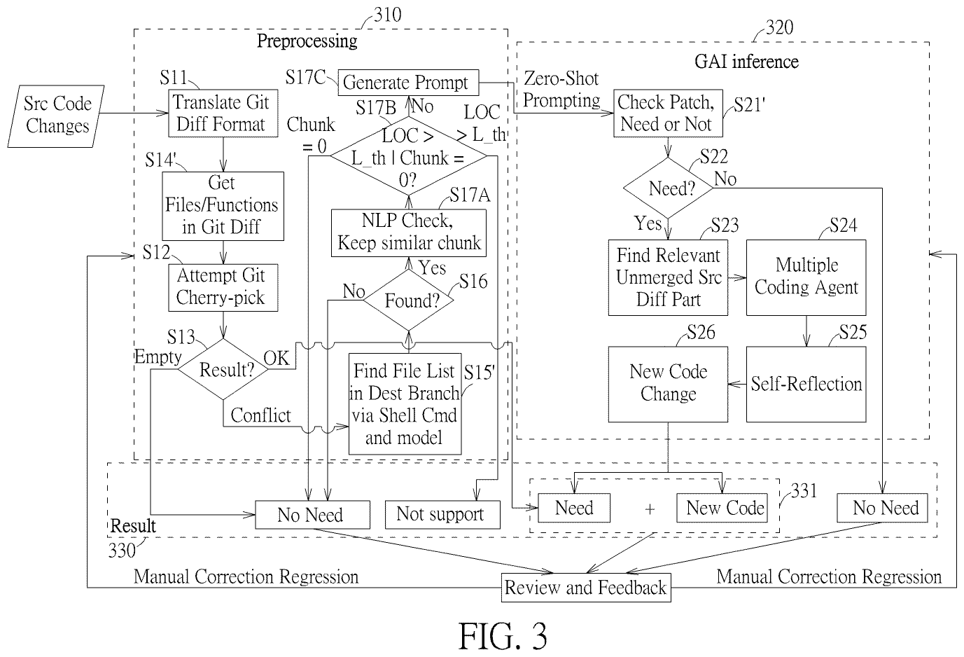

FIG. 3 is a diagram illustrating a second hybrid AI control scheme of the method according to an embodiment of the present invention, where the preprocessing 310 and the GAI inference 320 shown in FIG. 3 can be taken as examples of the preprocessing 111 and the GAI inference 121 shown in FIG. 1, respectively. Among the result 330 such as the preprocessing result of the preprocessing 310 and the inference result of the GAI inference 320, the determination results, including the positive determination result “Need” indicating that the patch porting is needed and the negative determination result “No Need” indicating that the patch porting is not needed, as well as an additional determination result “Not support” indicating that the patch porting is not supported for some special cases (e.g., a first case that a first predetermined condition “LOC>L_th” is met in Step S17B, where “L_th” may represent a threshold, for example, the threshold L_th may be equal to 200), can be taken as examples of the AI judging result shown in FIG. 1, and the new code (e.g., the new code change obtained from the GAI inference 320) within the sub-result 331 of the result 330 can be taken as an example of the AI generated patch shown in FIG. 1. This is for illustrative purposes only, and is not meant to be a limitation of the present invention. According to some embodiments, the AI-powered patch porting architecture 100 can determine whether it has access permission for accessing the source code (or the aforementioned at least one source code change thereof). If the determination result is positive, indicating that the AI-powered patch porting architecture 100 has the access permission, Step S11 is entered; otherwise, in a situation where the determination result is negative, indicating that the AI-powered patch porting architecture 100 does not have the access permission, the AI-powered patch porting architecture 100 obtains the additional determination result “Not support” correspondingly and therefore skips performing the preprocessing 310 and the GAI inference 320.

During performing the preprocessing 310 to generate the aforementioned at least one prompt according to the aforementioned at least one source code change of the source code, the NLP module 110 is capable of using the preprocessing 310 to translate Git Diff Format in Step S11, get the files/functions in Git Diff in Step S14′, attempt Git Cherry-pick in Step S12, determine in Step S13 the result of Git Cherry-picking, for example, by determining whether the result of Git Cherry-picking is OK or Empty or Conflict, try to find at least one file list having a chunk similar to Git Diff (or Src Diff) in Step S15′ for the case of determining that the result of Git Cherry-picking is Conflict, for example, in the destination (Dest) branch via at least one shell command (Cmd) and a predetermined preprocessing fuzzy searching model (e.g., a trained model) of machine learning (ML) (labeled “Find File List in Dest Branch via Shell Cmd and model” at Step S15′ shown in FIG. 3 for brevity), and afterward, in Step S16, determine whether any file list is found, perform NLP check for keeping any similar chunks in Step S17A for the case that the file list is found, determine whether any condition among two predetermined conditions such as the first predetermined condition “LOC>L_th” (e.g., L_th=200) and a second predetermined condition “Chunk=0” is met (labeled “LOC>L_th|Chunk=0” for brevity) in Step S17B, with the first predetermined condition “LOC>L_th” representing the condition that the lines of code (LOC) (i.e., the line count) of the similar chunks (or the set of similar code snippets) is greater than the threshold L_th (e.g., L_th=200) and with the second predetermined condition “Chunk=0” representing the condition that the chunk count of the similar chunks is equal to zero, and generate the aforementioned at least one prompt in Step S17C for the case of determining that no condition among the two predetermined conditions such as the first predetermined condition “LOC>L_th” and the second predetermined condition “Chunk=0” is met, in order to continue with the zero-shot prompting to trigger the GAI inference 320. In the above example, the Git can be taken as an example of the version management system involved with (e.g., invoked by) the preprocessing 310. This is for illustrative purposes only, and is not meant to be a limitation of the present invention. According to some embodiments, as long as the implementation of the present invention will not be hindered, the version management system involved with and/or invoked by the preprocessing 310 may vary.

For the case of determining that the AI-powered patch porting architecture 100 has the access permission, during performing the GAI inference 320 according to the aforementioned at least one prompt, the trained GAI module such as the GAI module 120 can check the patch of the source code (or “the source patch”) according to the source code change and/or the preprocessed result of the source code change to generate the patch porting summarization for indicating whether the patch porting is needed or not (labeled “Check Patch, Need or Not” for brevity) in Step S21′, determine in Step S22 whether the patch porting is needed, find the relevant unmerged (or non-ported) source difference part such as the set of source code snippets (labeled “Find Relevant Unmerged Src Diff Part” for brevity) in Step S23, invoke multiple coding agents to generate at least one temporary new code change according to the set of source code snippets and the set of destination code snippets (labeled “Multiple Coding Agent” for brevity) in Step S24, perform self-reflection on the multiple coding agents for optimizing the aforementioned at least one temporary new code change (labeled “Self-Reflection” for brevity) in Step S25, and optimize the aforementioned at least one temporary new code change to generate at least one optimized result of the aforementioned at least one temporary new code change to be the aforementioned at least one new code change (labeled “New Code Change” for brevity) in Step S26.

The aforementioned owner such as the R&D engineer(s) who are using the AI-powered patch porting architecture 100 shown in FIG. 1 can review the result 330 to confirm the determination result (e.g., the positive determination result “Need” or the negative determination result “No Need”) regarding whether the patch porting is needed, or even the additional determination result “Not support” for the special cases, and execute the patch porting according the new code within the sub-result 331 for the case of confirming that the patch porting is needed, and can send feedback to the AI-powered patch porting architecture 100 in order to perform manual correction regression on the preprocessing 310 and the GAI inference 320 (or the learning parameters thereof). For brevity, similar descriptions for this embodiment are not repeated in detail here.

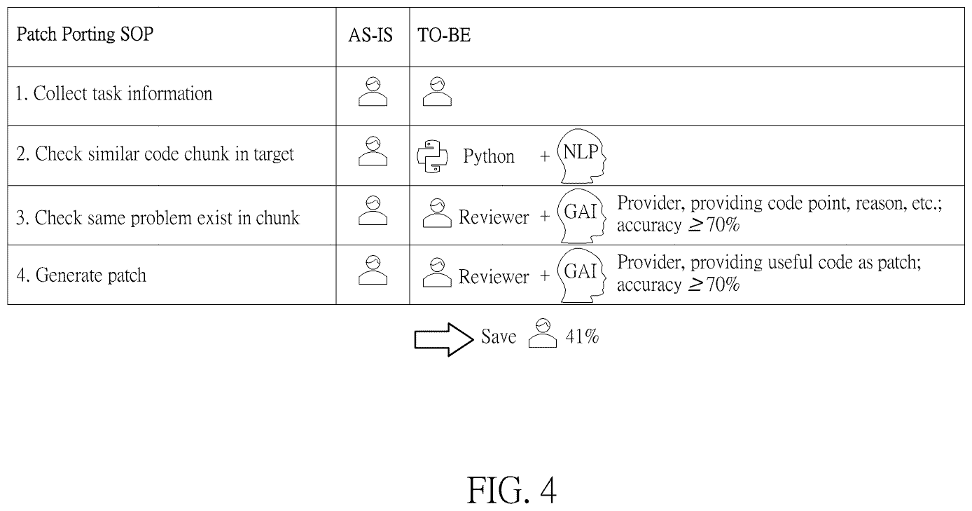

FIG. 4 is a diagram illustrating an example of comparison between the AI-powered patch porting control scheme and the non-AI-powered patch porting control scheme shown in FIG. 1 according to an embodiment of the present invention. When considering the patch porting SOP mentioned above, the non-AI-powered patch porting control scheme (labeled “AS-IS” for brevity) totally relies on manual operations, and the AI-powered patch porting control scheme (labeled “TO-BE” for brevity) can provide strong supports to the owner such as the R&D engineers who are using the AI-powered patch porting architecture 100, in particular, by using a management tool programmed with a predetermine high-level programming language such as Python plus the NLP module 110 (labeled “NLP” for brevity), and by using the trained GAI module such as the GAI module 120 (labeled “GAI” for brevity) as the provider for providing the code point, the reason, etc., for example, with the accuracy that is greater than or equal to 70%, and for providing the useful code as the patch to be ported, for example, with the accuracy that is greater than or equal to 70%, and therefore can save at least 41% of the software manpower, but the present invention is not limited thereto. According to some embodiments, the AI judging result (or the AI judgment) such as the code point, the reason, etc. and the accuracy thereof and/or the AI generated patch such as the useful code and the accuracy thereof may vary, and the software manpower saving percentage may vary correspondingly. For brevity, similar descriptions for this embodiment are not repeated in detail here.

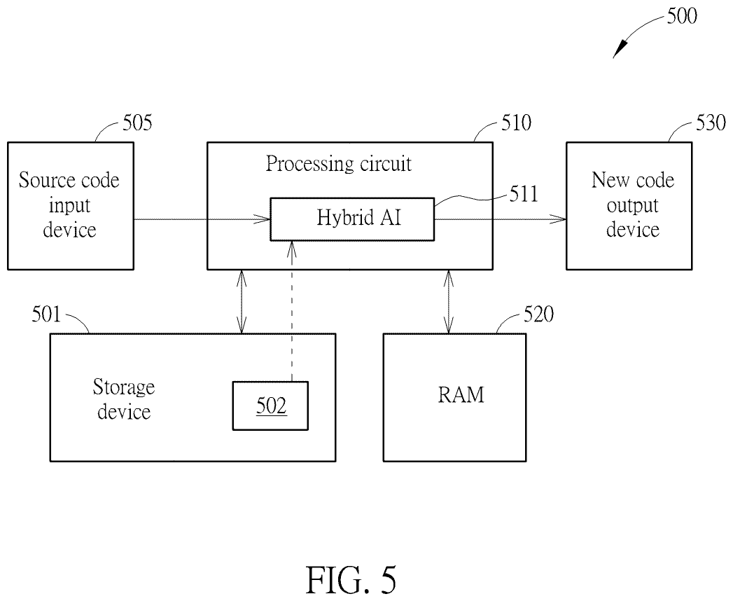

FIG. 5 is a diagram illustrating an electronic device 500 involved with the method according to an embodiment of the present invention. Examples of the electronic device 500 may include, but are not limited to: a personal computer (PC) such as a desktop computer and a laptop computer, a server, an all in one (AIO) computer, a tablet computer and a multifunctional mobile phone as well as a wearable device.

The electronic device 500 may comprise a processing circuit 510 that is capable of running a Hybrid AI framework 511 (labeled “Hybrid AI” in FIG. 5 for brevity) such as the whole framework of the AI-powered patch porting architecture 100 shown in FIG. 1, and may further comprise a computer-readable medium such as a storage device 501, a source code input device 505, a random access memory (RAM) 520 and a new code output device 530. The processing circuit 510 may be arranged to control operations of the electronic device 500. More particularly, the computer-readable medium such as the storage device 501 may be arranged to store a program code 502, for being loaded onto the processing circuit 510 to act as the Hybrid AI framework 511 running on the processing circuit 510. When executed by the processing circuit 510, the program code 502 may cause the processing circuit 510 to operate according to the method, in order to perform the associated operations of the Hybrid AI framework 511. For example, multiple program modules may run on the processing circuit 510 for controlling the operations of the electronic device 500, where the Hybrid AI framework 511 may be one of the multiple program modules, but the present invention is not limited thereto. In addition, the source code input device 505 may be arranged to input or receive multiple versions of the source code (or any source code difference between the multiple versions of the source code), the RAM 520 may be arranged to temporarily store the multiple versions of the source code (or the aforementioned any source code difference between the multiple versions of the source code), the Hybrid AI framework 511 running on the processing circuit 510 may be arranged to process the multiple versions of the source code (or the aforementioned any source code difference between the multiple versions of the source code), and more particularly, perform the preprocessing on the multiple versions of the source code (or the aforementioned any source code difference between the multiple versions of the source code) and perform the aforementioned inference, in order to generate one or more new codes such as one or more new code changes, and the new code output device 530 may be arranged to output or display the one or more new codes such as the one or more new code changes, but the present invention is not limited thereto. For example, the RAM 520 may be arranged to temporarily store the multiple versions of the source code (or the aforementioned any source code difference between the multiple versions of the source code) and the one or more new codes such as the one or more new code changes, and/or the storage device 501 may be arranged to store the multiple versions of the source code (or the aforementioned any source code difference between the multiple versions of the source code) and the one or more new codes such as the one or more new code changes.

In the above embodiment, the storage device 501 can be implemented by way of a hard disk drive (HDD), a solid state drive (SSD) and a non-volatile memory such as a Flash memory, the source code input device 505 can be implemented by way of a network interfacing (IF) device/circuit coupled to a network attached storage (NAS), the processing circuit 510 can be implemented by way of at least one processor, the RAM 520 can be implemented by way of a dynamic random access memory (DRAM), and the new code output device 530 can be implemented by way of a display device such as a liquid-crystal display (LCD) panel, an organic light-emitting diode (OLED) panel, another network IF device/circuit coupled to the NAS, etc., where the display device can be implemented as a touch-sensitive panel, but the present invention is not limited thereto. According to some embodiments, the architecture of the electronic device 500 and/or the components therein may vary.

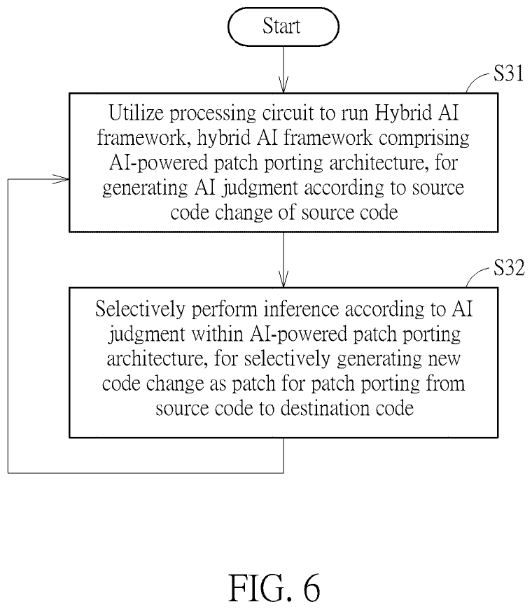

FIG. 6 is a flowchart of the method according to an embodiment of the present invention. The method can be applied to the electronic device 500 as well as the processing circuit 510 within the electronic device 500.

In Step S31, the electronic device 500 may utilize the processing circuit 510 to run the Hybrid AI framework 511, the hybrid AI framework 511 comprising the AI-powered patch porting architecture 100, for generating at least one AI judgment (e.g., the aforementioned at least one judging result) according to the aforementioned at least one source code change of the source code. For example, the operation of Step S31 may further comprise: generating the aforementioned at least one prompt, by using the preprocessing 111 within the AI-powered patch porting architecture 100, according to the aforementioned at least one source code change of the source code.

In Step S32, the processing circuit 510 (or the Hybrid AI framework 511 running thereon) may selectively perform the aforementioned inference according to the aforementioned at least one AI judgment within the AI-powered patch porting architecture 100, for selectively generating the aforementioned at least one new code change as the aforementioned at least one patch for the patch porting from the source code to the destination code. For example, the operation of Step S32 may further comprise: performing the inference such as the GAI inference 121 according to the aforementioned at least one prompt with the trained GAI module such as the GAI module 120 within the AI-powered patch porting architecture 100, for selectively generating the aforementioned at least one new code change as the aforementioned at least one patch for the patch porting from the source code to the destination code. For brevity, similar descriptions for this embodiment are not repeated in detail here.

For better comprehension, the method may be illustrated with the working flow shown in FIG. 6, but the present invention is not limited thereto. According to some embodiments, one or more steps may be added, deleted, or changed in the working flow shown in FIG. 6.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing patch porting control to enhance patch porting efficiency, the method being applied to a processing circuit within an electronic device, the method comprising:
utilizing the processing circuit to run a hybrid artificial intelligence (AI) framework, the hybrid AI framework comprising AI-powered patch porting architecture, for generating at least one AI judgment according to at least one source code change of a source code; and
selectively performing inference according to the at least one AI judgment within the AI-powered patch porting architecture, for selectively generating at least one new code change as at least one patch for patch porting from the source code to a destination code.

2. The method of claim 1, wherein generating the at least one AI judgment according to the at least one source code change of the source code further comprises:
generating at least one prompt according to the at least one source code change of the source code.

3. The method of claim 2, wherein selectively performing the inference according to the at least one AI judgment within the AI-powered patch porting architecture, for selectively generating the at least one new code change as the at least one patch for the patch porting from the source code to the destination code further comprises:
performing the inference according to the at least one prompt within the AI-powered patch porting architecture, for selectively generating the at least one new code change as the at least one patch for the patch porting from the source code to the destination code.

4. The method of claim 2, wherein generating the at least one prompt according to the at least one source code change of the source code further comprises:
generating the at least one prompt, rather than any patch list, according to the at least one source code change of the source code.

5. The method of claim 2, wherein the AI-powered patch porting architecture comprises a natural language processing (NLP) module; and generating the at least one prompt according to the at least one source code change of the source code further comprises:
using the NLP module during preprocessing according to the at least one source code change of the source code.

6. The method of claim 5, wherein the AI-powered patch porting architecture further comprises a trained generative artificial intelligence (GAI) module; and selectively performing the inference according to the at least one AI judgment within the AI-powered patch porting architecture for selectively generating the at least one new code change as the at least one patch for the patch porting from the source code to the destination code further comprises:
performing the inference according to the at least one prompt with the trained GAI module within the AI-powered patch porting architecture, for selectively generating the at least one new code change as the at least one patch for the patch porting from the source code to the destination code.

7. The method of claim 2, wherein generating the at least one prompt according to the at least one source code change of the source code further comprises:
generating the at least one prompt according to the at least one source code change of the source code, for prompting a trained generative artificial intelligence (GAI) module within the AI-powered patch porting architecture.

8. The method of claim 7, wherein generating the at least one prompt according to the at least one source code change of the source code further comprises:
preprocessing, by using a natural language processing (NLP) module within the AI-powered patch porting architecture, the at least one source code change of the source code to generate the at least one prompt, for prompting the trained GAI module within the AI-powered patch porting architecture.

9. The method of claim 1, wherein the inference comprises inference of determining whether the patch porting is needed to generate a determination result, and further comprises inference of selectively generating the at least one new code change according to the determination result.

10. The method of claim 1, wherein generating the at least one prompt according to the at least one source code change of the source code further comprises:
performing preprocessing on the at least one source code change to generate the at least one prompt, wherein the preprocessing comprise at least one source patch analysis operation, and the at least one source patch analysis operation comprises operations of:
analyzing at least one source code difference between a previous version and a current version of the source code, for determining a set of source code snippets within at least one source branch of the source code that correspond to the at least one source code difference, wherein the at least one source code change comprises the at least one source code difference; and
searching at least one destination branch of the destination code, for determining a set of similar code snippets, the set of similar code snippets being a set of destination code snippets within the at least one destination branch that are similar to the set of source code snippets.

11. The method of claim 1, wherein the inference comprises at least one inference operation, and the at least one inference operation comprises:
a patch porting summarization inference operation, for generating a patch porting summarization, wherein the patch porting summarization generated by the patch porting summarization inference operation at least comprises a determination result for indicating whether the patch porting is needed.

12. The method of claim 11, wherein in response to the determination result being equal to a first determination result which indicates that the patch porting is needed, the patch porting summarization generated by the patch porting summarization inference operation further comprises one or more necessary reasons regarding why the patch porting is needed.

13. The method of claim 11, wherein in response to the determination result being equal to a first determination result which indicates that the patch porting is needed, the at least one inference operation further comprises:
a new code change inference operation, for generating the at least one new code change as the at least one patch for the patch porting from the source code to the destination code.

14. The method of claim 1, wherein the at least one source code change comprises at least one source code difference between a previous version and a current version of the source code.

15. An apparatus that operates according to the method of claim 1, wherein the apparatus comprises at least the processing circuit within the electronic device.

16. The apparatus of claim 15, wherein the apparatus comprises the electronic device.

17. A computer-readable medium related to the method of claim 1, wherein the computer-readable medium stores a program code which causes the processing circuit to operate according to the method when executed by the processing circuit.
